(19) United States
(12) Patent Application Publication
(10) Pub. No.: US 2009/0287714 A1
(43) Pub. Date: Nov. 19, 2009

(54) Method and Apparatus for Community-Based Comparison Shopping Based on Social Bookmarking

(75) Inventors: Venugopal Vasudevan, Palatine, IL (US); John D. Bruner, South Barrington, IL (US); Nitya Narasimhan, Lake Zurich, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/122,891

(22) Filed: May 19, 2008

(51) Int. Cl. G06F 17/30

(52) U.S. Cl. 707/10; 707/6; 707/E17.001

(57) ABSTRACT

A method and apparatus for sharing product information amongst users of a computer network using productmarks. A productmark for a product is created by a user of the network and includes a product identifier, an annotation containing user comments, a username that identifies the creator of the productmark, and a categorization tag that identifies the user's level of interest in purchasing the product. Productmarks are stored in a database that may be queried using a product identifier, a username, a categorization tag or any combination of these to retrieve productmarks. A user network device provides access to the database and includes modules for creating and uploading productmarks to the database a module for querying and downloading productmarks from the database. A peer-to-peer communication session may be formed relating to a particular product and/or geographical location.

### BACKGROUND

Social bookmarking sites (e.g. del.icio.us and Digg.com) have become popular ways for Internet users to keep track of web sites of interest on the World Wide Web (WWW). These sites allow people to post the web URL (Uniform Resource Locator) of interest with an associated tag, which describes the way they want to classify this URL, and a textual annotation. For example, the URL www.money.com/Motorola-story.asp might be posted together with a tag. “favorable-Motorola-story” and a textual annotation “Lehman upgraded Motorola stock due to . . . ”. Such sites have been effective means for both content discovery and people discovery.

When a URL is bookmarked, the user is shown the identities of others who have bookmarked the same item (therefore probably follow Motorola stock) and can also view the other sites they've bookmarked (perhaps information about other promising technology stocks). Thus, social bookmarking is an effective means of discovering content of interest and people with similar tastes.

Content and people discovery is also a feature found in the comparison shopping domain where a user wants to find both items of interest (e.g. European style couch at the best possible price) and people with similar tastes. Product forums allow users to share information about products, prices, deals etc. Buyer aggregation allows users to join with other users to buy multiple items are reduces prices (e.g. on a “buy 3 get 1 free blue light special”).

Social shopping is a method of e-commerce in which consumers shop in an Internet-based social networking environment similar to MySpace.com. Sites include Kaboodle.com, Wists.com and StyleHive.com. Some sites allow users to create custom shopping lists and share them with friends. Some services even allow users to shop together, synchronously, to complete the social environment.

### BRIEF DESCRIPTION OF THE FIGURES

The accompanying figures, in which like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a system for sharing product information in accordance with some embodiments of the present invention.

FIG. 2 is a diagrammatic representation of a productmark database in accordance with some embodiments of the present invention.

FIG. 3 is a flowchart of a method for sharing product information amongst users of a computer network, in accordance with some embodiments of the present invention.

FIG. 4 is a flowchart of a method, in accordance with some embodiments of the present invention, for a user of a computer network to share information about a product with other users of the computer network.

FIG. 5 is a flowchart of a method, in accordance with some embodiments of the present invention, for a user to access a database of productmarks over a network.

FIG. 6 is a flow chart of a further method for users to share product information in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to community-based comparison shopping based on social networking. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It will be appreciated that embodiments of the invention described herein may comprise one or more conventional processors and unique stored program instructions that control the one or more processors to implement, in conjunction with certain non-processor circuits, some, most, or all of the functions relating to community-based comparison shopping based on social networking described herein. The non-processor circuits may include, but are not limited to, a radio receiver, a radio transmitter, signal drivers, clock circuits, power source circuits, and user input devices. As such, these functions may be interpreted as a method to provide network access and to enable community-based comparison shopping based on social networking. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

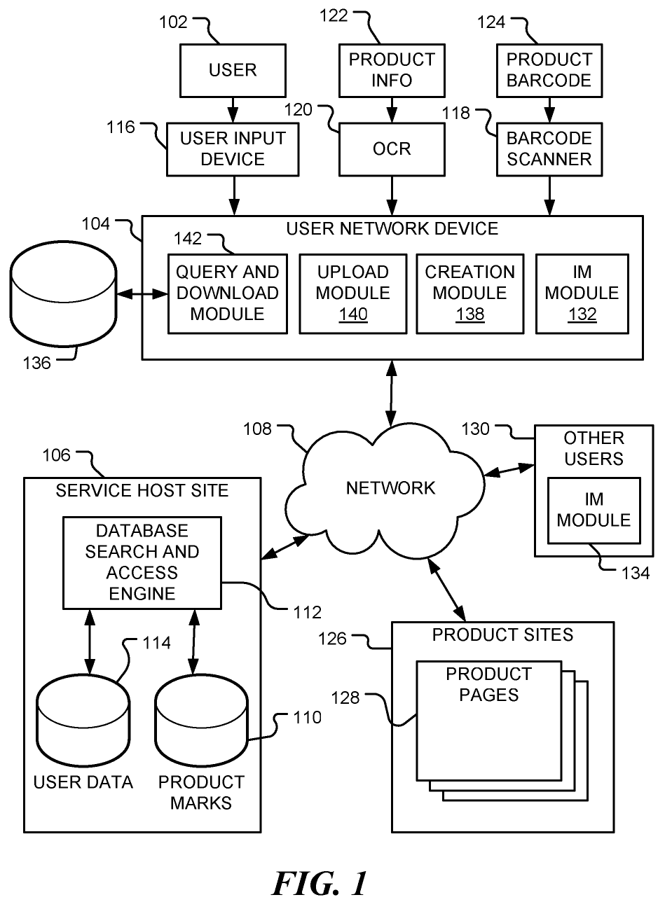

FIG. 1 is a block diagram of a system for sharing product information amongst users of a network in accordance with some embodiments of the present invention. In FIG. 1, a user (or shopper) 102 uses a network device 104 to access a service host site 106 that provides services to enable comparison shopping based on social bookmarking. In this embodiment the user network device 104 and the service host server 106 communicate via a network 108, which may be the Internet, for example. The service host site 106 enables a user to store information about products and also to discover information about products and other people interested in those products. The service host site 106 also facilitates shopper aggregation, to allow users to take advantage of bulk buying opportunities.

In one embodiment of the present invention, each product category (e.g. “bag of peas”) or branded product (e.g. “Whirlpool Fridge”) is associated with a unique “productmark” that includes product identifier such as a Uniform Resource Locator (URL). Generally, a URL is a global identifier of network-retrievable document. In the context of the World Wide Web, a URL may also be referred to as a “Web address” or simply “address”. The term “productmark” is used here to describe a bookmark for product information as distinct from a general bookmark. Thus, one component of a productmark is a global identifier of network-retrievable information relating to a product category or a branded product.

The productmarks created by users are stored in a database 110. The service host accesses the productmark database 110 using a search and access engine 112. In addition, the service may also maintain a database 114 of user information, in a similar fashion to a conventional social networking site. The user information may include the user's location to enable a user to find other users in a specified region.

A person 102 using a computer, or other network device 104, may create a productmark with one or more inputs (e.g. 2-clicks of a selection button on user input device 116). The network device may be, for example, a computer, a mobile telephone, a personal digital assistant or other portable electronic device. A barcode scanner 118 (such as telephone-based scanners) or optical character recognition (OCR) system 120 can record the name and price of an item with a single click. For example, product packaging or other product information 122 can be input to the user internet device 104 using the OCR system 120. Alternatively, the product information can be entered using the barcode scanner 118 by scanning a barcode 124. A radio-frequency identification (RFID) tag reader (not shown in the figure) may also be used to enter a product identifier. With another click, a user can publish this price and product information to the service host site 106. A productmark contains a product identifier and additional information. In one embodiment, a productmark includes an annotation, such as sale information, store location, etc., and a tag such as ‘ready-to-buy’, ‘getting-warm’, ‘just-looking’, a username of the creator of the productmark and the date the mark was created or last modified.

Productmarks may be used for content discovery. The databases 114 and 110 contain user profiles and user productmarks, respectively. The user data may also include information, such as general bookmarks. The database may be indexed by product identifier (e.g. URL) and/or by username, so that a user may find all products bookmarked by a particular user or all users that have bookmarked a certain product. Content discovery may be performed, for example, by clicking on any of a user's productmarks. The search and access engine 112 may be used to provide a user access to all the other people who have shown interest in the same product. This may be done by querying the database 110 using the product identifier. In one embodiment of the invention, the productmarks include a date, so that a user may find productmarks created or modified within a specified time period. The user could further query the annotations of corresponding productmarks to get prices on the same product in different locations based on user-generated content. The annotations of the productmarks may also contain links to product web sites 126 provided by merchants and manufacturers, for example, where a user can access pages 128 that provide product information and/or purchase services.

Productmarks may also be used for people discovery. Traditional social bookmarking user interfaces (UI's) may be used to browse the productmarks of all people who share a productmark X with you. For example, if X is a productmark for a particular MP3 music player, a user can discover the other products being examined by people in the market for the same MP3 music player. In this example, a user would discover a list of people who had entered a productmark X (by querying the database using the URL of X), and then retrieve the productmarks of people on the list (by querying the productmark database using the name of a person on the list).

Productmarks may be used for buyer aggregation. For example, for any productmark, a user can find all the other people (filtered by zip code, for example) who have tagged the same productmark as “ready-to-buy”.

A user may join or initiate a communication session with other users 130 that have created productmarks for the same product. Traditional communication overlays may be used to set up the session amongst all people sharing that productmark. For example, the user may use an Instant Messaging (IM) tool 132 to interact with the corresponding IM tools 134 of other users. This process enables a collection of buyers with common product interests to form a collective that can go stores having “blue light special” sales and purchase large product orders at a discount. The process also enables users to share information with and ask questions of other users.

Manufacturers and retailers may be encouraged to create product marks for their own products and to join in communication sessions to provide additional information and to receive feedback from customers and potential customers.

A user 102 may store productmarks in a local memory 136 so that they can be accessed when the user in not connected to the network or to provide a cache for faster access. For example, if a user is about to visit a grocery store, he or she may download productmarks pertaining to his or her grocery list and store them for later use.

The user network device 104 provides a user with access to the computer network so as to enable sharing of product information amongst users of the computer network. The user network device 104 includes a creation module 138 for creating a productmark, an upload module 140 for uploading the productmark to a service host site, via the computer network, for storage in a productmark database, and query and download module 142 for querying the productmark database and downloading productmarks from the service host site 106.

The potential negatives of a productmarking scheme to retailers (lower profit margins), and associated resistance to such a scheme, can be mitigated by leveraging the social bookmark scheme to provide value-added services that would otherwise be unavailable to them. Examples of such services include:

The number of productmarks for a particular product indicates the latent demand for such a product (i.e. the number of “window shoppers” for that product)

The specificity of bookmarks (for “generic” peas vs. “Birds Eye” peas) could indicate the brand recognition for a particular product, or the importance of branding in general for a product.

The speed of formation of buyer aggregates for a blue light special might indicate the price firmness for that product.

Data mining across people's productmarks may capture unusual product affinities that could drive store product selection or in-store shelf placement (e.g. what if those who mark Pepperidge Farm cookies also tend to buy expensive wines?).

In general, these services are enabled when a user has the capability to aggregate information found in a number of downloaded product marks. Accordingly, the user network device may include a module for aggregating information in downloaded productmarks.

By adapting social bookmarking architectures in a novel manner, the present invention allows a user to shop in a way that is far more agile and effective than traditional comparison shopping. This is achieved by allowing the user to leverage community, affinity and location.

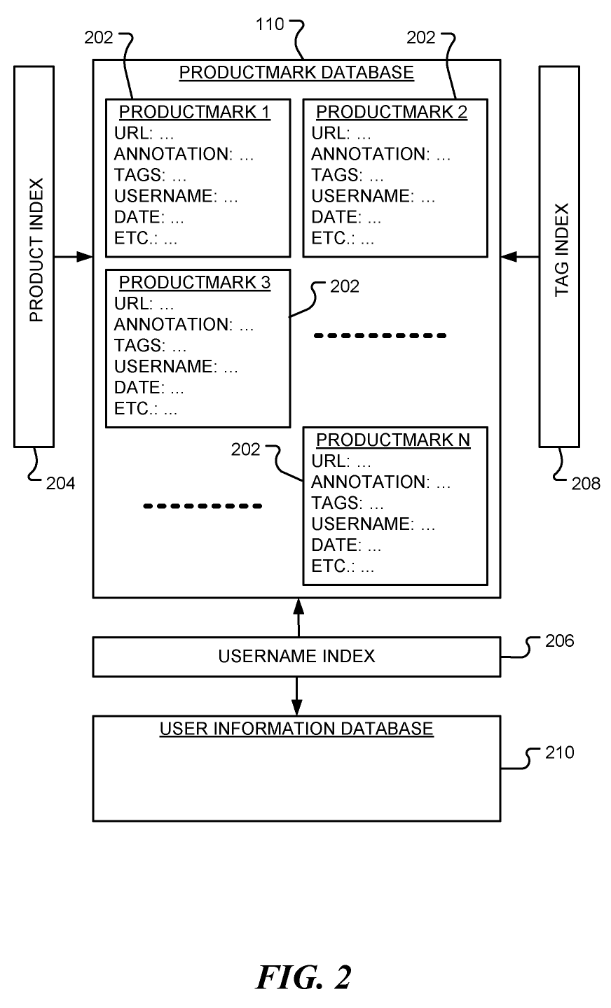

FIG. 2 is a diagrammatic representation of a productmark database 110 in accordance with some embodiments of the present invention. The productmark database 110 contains a number of productmarks 202. Each productmark is stored as an entry in the database and has a set of fields. The fields may include, for example, a product URL, an annotation (such as sale information, store location or other user comments), a categorization tag (such as ‘ready-to-buy’, ‘getting-warm’, ‘just-looking’), the creation date and the username of the creator. In this embodiment, the database is indexed by product identifier 204, by username 206 and by categorization tag 208 to enable rapid retrieval of productmarks when the database is queried using any combination of these fields. These fields provide unique keys. The username index may also be used to access a user information database 210. Information in the user information database 210 may be used to filter results retrieved from the productmark database. For example, the user's location may be used to select only productmarks created by users in a certain geographical location.

The product URL may also be used as an index to other product databases (not shown) maintained by the service host or accessed over the network.

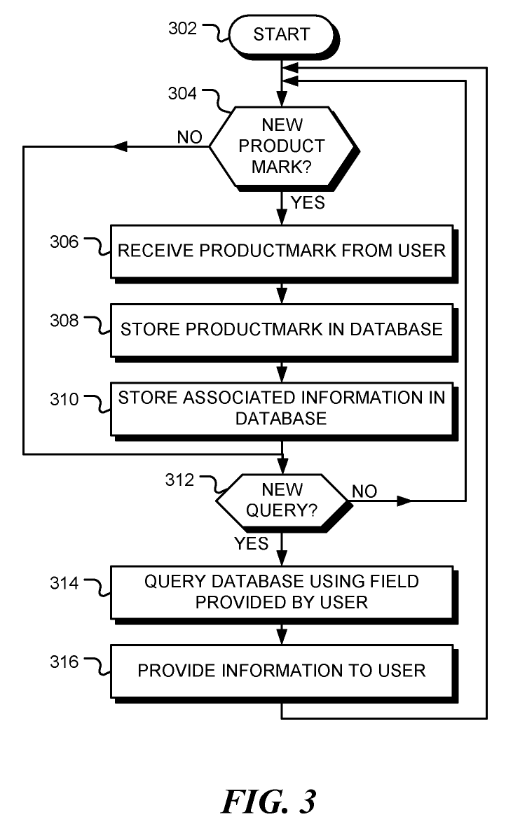

FIG. 3 is a flowchart of a method for sharing product information amongst users of a computer network, in accordance with some embodiments of the present invention.

The method may be performed by a computer of a service host site. Following start block 302 in FIG. 3, the arrival of a new productmark created by a user of the network is detected at decision block 304. As described above, the productmark comprises a product identifier, such as a uniform resource locator (URL), an annotation containing user comments and a categorization tag that identifies the user's level of interest in purchasing the product. If a new productmark is detected, as depicted by the positive branch from decision block 304, the productmark is received at block 306 and is stored in a database at block 308. Additionally, at block 310, associated information is stored in the database. This information may include a username or some other identifier of the creator of the productmark, the location of the creator, and the date the productmark was created or received. This information may be provided by the user or generated at the service host site. If no productmark arrival is detected, as depicted by the negative branch from decision block 304, flow continues to decision block 312. At decision block 312, the arrival of a user request to query the data base is detected at decision block 312. At block 314 the database is queried using the field or combination of fields provided by the user. For example, the database may be queried using a product URL, a username, a creation date, a geographical location, a categorization tag or any other field, or any combination of fields. Matching productmarks and other information retrieved from the database is provided to the user at block 316. For example, is the database was queried using a product URL, the matching productmarks are provided to the user. The annotations of the matching productmarks allows the user to discover product information, the corresponding usernames allow the user to discover other people interested in the product. If, for example, the database was queried using a username, the list of productmarks associated with that user may provided, together with other user information. This enables a user to discover other products of interest to someone with at least one common product of interest.

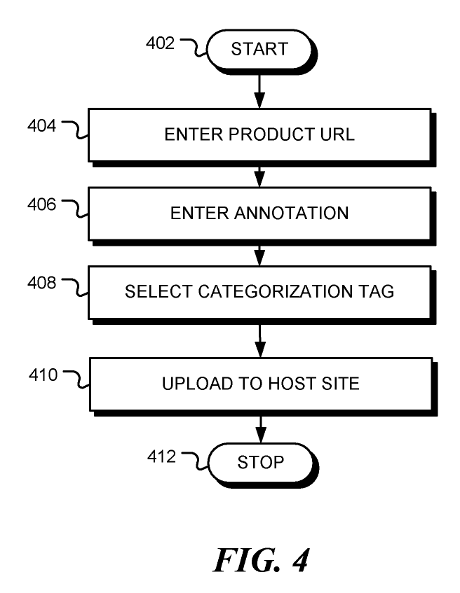

FIG. 4 is a flowchart of a method, in accordance with some embodiments of the present invention, for a user of a computer network to share information about a product with other users of the computer network. Following start block 402 in FIG. 4, the user enters a product identifier into a network device at block 404. The product identifier may be entered directly using a user interface such as a mouse, keyboard, touch-screen, or speech recognition system. Alternatively, the product identifier may be entered indirectly using a user interface or using a barcode scanner to scan the product's barcode, using an optical character recognition system (OCR) to enter text relating the product (such as a textual description of the product) or providing an image of the product (using a camera or scanner for example). The indirect information may be using to discover a corresponding product identifier by searching local or networked information. For example a barcode can be converted to a product description using an Internet database such as http://www.upcdatabase.com.

When incomplete product information (such as an image) is entered, contextual information may be used to aid the identification of the product. Contextual information may include, for example, the name or location of store where a photograph was taken, or the retailer name when the image is scanned from a catalogue or downloaded from an on-line catalogue. Location information may be provided by a global positioning system (GPS).

At block 406, the user enters an annotation for the productmark. The annotation comprises comments or additional information such as product reviews, sales price and/or merchant links.

At block 408 the user selects a categorization tag that identifies this or her level of interest in purchasing the product. The tags may include ‘already-own’, ‘ready-to-buy’, ‘getting-warm’, and ‘just-looking’, for example.

At block 410, the productmark, comprising the product URL, the annotation, the categorization tag and any other fields, is uploaded to a server of the network for inclusion in a database of productmarks. The creation of the product mark is completed and the method terminates at block 412.

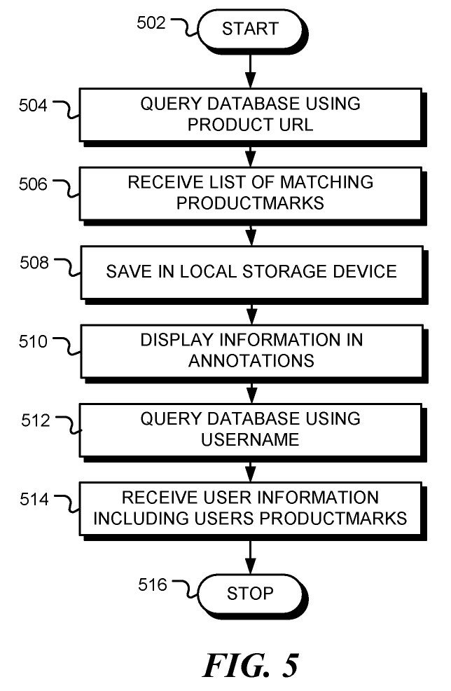

FIG. 5 is a flowchart of a method, in accordance with some embodiments of the present invention, for a user to access a database of productmarks over a network, such as the Internet. Following start block 502 in FIG. 5, a user accesses a service host site via a network and searches for a particular product at block 504. In effect, this is a request for the service host to query its database of productmarks for those productmarks that have a matching product identifier. The user may provide additional ‘filters’ to reduce the number of matching productmarks. For example, the search may be limited to productmarks created within a specified time period (e.g. marks created in the last month) or a within a geographical region (e.g. within a specified postal area or within some radius of a specified location). The search may also be limited to only those productmarks having a specified categorization tag. At block 506 the user receives a list of matching productmarks. The search and presentation of the matching products may be performed by a browser or similar software application operating on the user's network device using techniques known to those of ordinary skill in the art.

Optionally, at block 508, the productmarks may be saved in a local memory, such a flash memory or hard disc drive, for use by the user when he or she is not connected to the network.

At block 510 the user may display the information contained in the annotations of the productmarks. This allows that user to discover information about the product provided by other users.

Each productmark includes the username of its creator. Optionally, a block 512, the user may query the database for information relating to a selected username. This information, received at block 514, may include the productmarks associated with the selected username, and a personal profile associated with the selected username. In this way the user can discover other people interested in similar products and also discover other products, possibly related to originally searched product. The process may end at block 516 or the user may continue to search for other products or people.

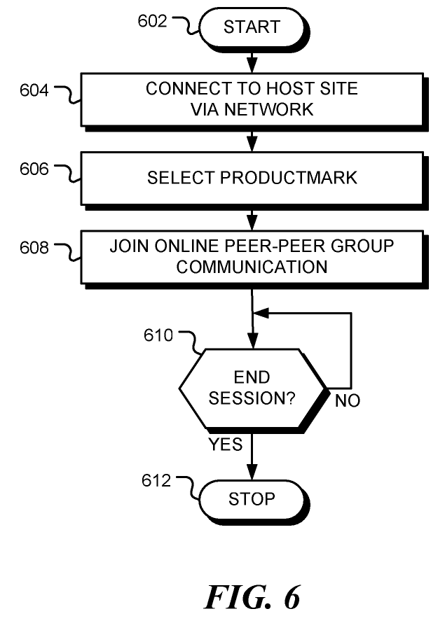

FIG. 6 is a flow chart of a further method for users to share product information in accordance with some embodiments of the present invention. Following start block 602 in FIG. 6, a user communicates with a service host site via a network at block 604 and selects a productmark at block 606. At block 608 the user chooses to join an on-line peer-to-peer group communication session relating to the product identified in the selected product mark. The communication session may be conducted using known techniques, such as instant messaging (IM), voice over Internet Protocol (VoIP) or services provided by Skype or Twitter. This enables users to communicate and share information pertaining to the product. The communication session continues until, as depicted by the positive branch from decision block 610, the session terminates at block 612.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for sharing product information amongst users of a computer network, the method comprising:
receiving, via the network, a productmark for a product, the productmark being created by a user of the network and comprising:
a product identifier;
an annotation containing user comments;
a username that identifies the creator of the productmark; and
a categorization tag that identifies the user's level of interest in purchasing the product;
storing the productmark in a database;
enabling users of the network to query the database using a product identifier, to retrieve matching productmarks; and
enabling users of the network to query the database using a username, to retrieve productmarks created by the user having that username.

2. A method in accordance with claim 1, wherein the categorization tag identifies a geographical location where the user viewed the product, the method further comprising:
enabling users of the network to query the database, using a product identifier and a geographical location, to retrieve matching productmarks that were created by users in the geographical location.

3. A method in accordance with claim 1, wherein the productmark further comprises a date the productmark was created or last modified, the method further comprising:
enabling users of the network to query the database using a range of productmark dates.

4. A method in accordance with claim 1, further comprising: enabling users of the network to query the database using a categorization tag.

5. A method for a user of a computer network to share information about a product with other users of the computer network, the method comprising:
creating productmark for the product, the productmark comprising:
a product identifier;
an annotation containing user comments;
a username that identifies the creator of the productmark; and
a categorization tag that identifies the user's level of interest in purchasing the product;
uploading the productmark to a server of the network for inclusion in a database of productmarks; and
accessing the database of productmarks.

6. A method in accordance with claim 5, further comprising:
selecting product identifier; and
joining a peer-peer a communication session to communicate, via the network, with other users who have selected the same product identifier.

7. A method in accordance with claim 5, further comprising:
selecting product identifier; and
joining a peer-peer a communication session to communicate, via the network, with other users who are located within a selected geographical area and have indicated a specified level of interest in the product associated with the selected product identifier.

8. A method in accordance with claim 5, wherein the network comprises the Internet and the communication session comprises an instant messaging (IM) session.

9. A method in accordance with claim 5, wherein creating the productmark for the product comprises:
scanning a barcode of the product to a network device of the user;
decoding the barcode;
generating a corresponding annotation; and
selecting a corresponding categorization tag.

10. A method in accordance with claim 5, wherein creating the productmark for the product comprises:
scanning a textual description of the product to a network device of the user;
the network device recognizing the text of the textual description using an character recognition system;
generating a corresponding annotation; and
selecting a corresponding categorization tag.

11. A method in accordance with claim 5, wherein creating productmark for the product comprises:
entering an image of the product to a network device of the user;
entering contextual information to the network device;
the network device using the contextual information and the image to identify the product identifier;
generating a corresponding annotation; and
selecting a corresponding categorization tag.

12. A method in accordance with claim 11, wherein the contextual information is used to identify a supplier of the product.

13. An apparatus for sharing product information amongst users of a computer network, the apparatus comprising:
a productmark database storing productmarks, each productmark created by a network user and comprising:
a product identifier;
an annotation containing user comments relating to the product;
a categorization tag identifying the user's level of interest in purchasing the product; and
a username identifying the creator of the productmark;
a user information database storing information pertaining to network users; and
a search and access engine able to retrieve information from the productmark database and the user information database in response to queries by users of the network.

14. An apparatus in accordance with claim 13, wherein the product database is indexed by product identifier, categorization tag and username, and wherein the user information database is indexed by username.

15. A user network device for providing a user access to the computer network to enable sharing of product information amongst users of the computer network, the user network device comprising:
a creation module for creating a productmark, the productmark comprising a product identifier, an annotation containing user comments relating to the product, a categorization tag identifying the user's level of interest in purchasing the product, and a username identifying the creator of the productmark;
an upload module for uploading the productmark to a service host site, via the computer network, for storage in a productmark database; and
a query and download module for querying the productmark database and downloading productmarks from the service host site.

16. A user network device in accordance with claim 15, further comprising a peer-to-peer communication module for connecting the user to a communication session for a product selected by the user.

17. A user network device in accordance with claim 15, wherein the creation module for creating a productmark comprises:
a means for obtaining a barcode of the product; and
a means for decoding the barcode of the product to obtain a product identifier.

18. A user network device in accordance with claim 15, wherein the creation module for creating a productmark comprises:
a means for obtaining a scanned textual description of the product; and
a means for recognizing text in the scanned textual description of the product and obtaining a product identifier from the text.

19. A user network device in accordance with claim 15, wherein the query and download module comprises a module for displaying annotations of downloaded productmarks.

20. A user network device in accordance with claim 15, further comprising a memory for storing downloaded productmarks.

21. A user network device in accordance with claim 15, wherein the query and download module comprises a module for aggregating information in download product marks.
